(19) United States
(12) Patent Application Publication
(10) Pub. No.: US 2011/0134360 A1
(43) Pub. Date: Jun. 9, 2011

(54) ILLUMINATION UNIT, ILLUMINATION DEVICE, AND LIQUID CRYSTAL DISPLAY APPARATUS

(75) Inventors: Tetsuya Ueno, Osaka-shi (JP); Yukihide Kohtoku, Osaka-shi (JP)

(73) Assignee: SHARP KABUSHIKI KAISHA, Osaka-shi, Osaka (JP)

(21) Appl. No.: 13/002,769

(22) PCT Filed: Apr. 9, 2009
(86) PCT No.: PCT/JP2009/057266

§ 371 Date: Jan. 6, 2011

(30) Foreign Application Priority Data
Jul. 22, 2008 (JP) 2008-188958

(51) Int. Cl. G02F 1/13357; F21V 7/22

(52) U.S. Cl. 349/62; 362/613

(57) ABSTRACT

Light-emitting unit (11) includes: lightguides (7a) and (7b) having light-emitting surfaces (12a•b) for emitting light in surface-emitting manner; and light sources (5a•b), being provided on back sides with respect to light-emitting surfaces (12a•b), lightguides (7a•b) including: light-emitting sections (10a•b) each having one surface which is corresponding one of light-emitting surfaces (12a•b); lightguide sections (9a•b) each having one end which is connected to corresponding one of light-emitting sections (10a•b) and each having other end which serves as incident surface of light emitted from corresponding one of light sources (5a•b); and reflecting surfaces (18a•b) being formed in light-emitting sections (10a•b) so as to be located to interpose between lightguide sections (9a•b), and to divide light-emitting surface into light-emitting surfaces (12a•b), lightguide sections (9a•b) being provided on back sides with respect to light-emitting surfaces (12a•b) so as to guide light to light-emitting surfaces (12a•b) by reflecting light on reflecting surfaces (18a•b). This makes it possible to realize illumination unit which is slim, uniform in light emission, and improved in ease of rework process.

### TECHNICAL FIELD

The present invention relates to an illumination unit and an illumination device each of which is used as a device such as a backlight of a liquid crystal display apparatus, and to a liquid crystal display apparatus having the illumination device.

### BACKGROUND ART

Recently, liquid crystal display apparatuses rapidly diffuse in place of display apparatuses having cathode-ray tubes (CRTs). Advantages of the liquid crystal display apparatuses such as energy saving, slimness, and lightness in weight are taken so that the liquid crystal display apparatuses are widely provided to liquid crystal televisions, monitors, portable phones, etc. Enhancement of the advantages includes improvement of illumination devices (so-called backlight) each of which is provided to a back part of a liquid crystal display apparatus.

Illumination devices are broadly classified into a side light-type (also referred to as edge-light type) and a direct-type.

In a direct-type illumination device, a plurality of light sources are arrayed behind a liquid crystal display panel so as to directly irradiate the liquid crystal display panel with light. This makes it possible to obtain a high luminance even in the case of a large screen. For this reason, direct-type illumination devices are mainly adopted in large liquid crystal displays having sizes of not less than 20 inches. However, current direct-type illumination devices have large thicknesses from approximately 20 mm to approximately 40 mm. This is an obstacle to a further slimming down of liquid crystal displays.

In a side light-type illumination device, a lightguide is provided behind a liquid crystal display panel, and a light source is provided to a lateral end of the lightguide. Light emitted from the light source is reflected by the lightguide so that the liquid crystal display panel is irradiated with the light indirectly and uniformly. Such a structure makes it possible to realize slimming down and a high uniformity of luminances of an illumination device, although the luminances are low. For this reason, side light-type illumination devices are mainly adopted in small or medium-sized liquid crystal displays such as those of portable phones and notebook PCs.

Examples of the side light-type illumination devices encompass one disclosed in Patent Literature 1. As illustrated in FIG. 6, Patent Literature 1 discloses an arrangement having: a main lightguide plate GLBM having a light-emitting surface for emitting light so as to planarly spread the light; and sub lightguide plates GLBS and GLBS2 provided on the back side with respect to the main lightguide plate GLBM. Further, a light reflector REF for optical connection is provided on each of both sides of the main lightguide plate GLBM and the sub lightguide plates GLBS and GLBS2. The light reflector REF has a substantially U-shaped cross-section. As a result, light from a light source provided on the back side with respect to the sub lightguide plates GLBS and GLBS2 is reflected by the light reflector REF while passing through the main lightguide plate GLBM and the sub lightguide plates GLBS and GLBS2. Thus, the light is emitted from the light-emitting surface in the surface-emitting manner.

However, according to the arrangement, the light from the light source is reflected toward the light-emitting surface by the light reflector REF provided on each of both sides of the main lightguide plate GLBM and the sub lightguide plates GLBS and GLBS2. Therefore, a uniform surface light emission cannot be realized in a case where the backlight has a large size.

In view of such a problem, Patent Literature 2 discloses a backlight structure in which a plurality of backlight devices are connected by a serial connection method. As illustrated in FIG. 7, in the backlight structure, a plurality of backlight devices 200 each having a reflecting section 220 are disposed so that a reflecting section 220 of a backlight device 200 and an adjacent backlight device 200 overlap each other.

Such a structure makes it possible to secure a broad light-emitting section in a compact structure. Accordingly, the structure is suitably applicable to a large liquid crystal display.

Such an illumination device in which a plurality of light-emitting units are arranged each of which is a combination of a light source and a lightguide plate is referred to as tandem-type illumination device.

### CITATION LIST

### Patent Literature 1

Japanese Patent Application Publication, Tokukai, No. 2005-310611 A (Publication Date: Nov. 4, 2005)

### Patent Literature 2

Japanese Patent Application Publication, Tokukai, No. 2007-115695 A (Publication Date: May 10, 2007)

### SUMMARY OF INVENTION

### Technical Problem

In a case where one of various members provided below a light-emitting unit and/or a lightguide in an illumination device made up of a plurality of backlight devices has a failure, e.g., in a case where a light-emitting diode (LED) to be used as a light source is damaged in a manufacturing step, a rework process is performed in which a light-emitting unit having a failure is replaced with a nondefective one in order that the failure is removed.

However, in the backlight structure disclosed in Patent Literature 2, the reflecting section 220 of the backlight device 200 and the adjacent backlight device 200 are disposed so as to overlap each other. Therefore, even if a failure of one backlight device 200 is found after the backlight devices 200 are combined, it is impossible to remove only the backlight device 200 having the failure. That is, it is necessary to remove an adjacent backlight device 200 overlapping the backlight device 200 having the failure.

Thus, the backlight structure disclosed in Patent Literature 2 does not allow removal of only a backlight device having a failure. This makes the rework process troublesome.

The present invention was made in view of the problem. An object of the present invention is to provide an illumination unit, an illumination device, and a liquid crystal display apparatus which are slim, uniform in light emission, and improved in ease of a rework process.

### Solution to Problem

In order to attain the object, an illumination unit of the present invention is an illumination unit for use as a backlight of a transmissive display panel, includes: a first lightguide and a second lightguide; a light-emitting surface made up of respective light-emitting surfaces of the first lightguide and the second lightguide; and a first light source and a second light source, being respectively provided on respective back sides with respect to the light-emitting surfaces, each of the first lightguide and the second lightguide including: a light-emitting section whose one surface is corresponding one of the light-emitting surfaces; corresponding one of a first lightguide section and a second lightguide section having (i) one end being connected to the corresponding one of the light-emitting sections and having (ii) other end serving as an incident surface of light emitted from the corresponding one of the first light source and the second light source respectively; and a reflecting surface formed in the light-emitting section so as to be located to interpose between the first lightguide section and the second lightguide section, and to divide the light-emitting surface into a first region and a second region, the first lightguide section and the second lightguide section being respectively provided on respective back sides with respect to the first region and the second region of the light-emitting surface and formed so as to guide the light to the first region and the second region by reflecting the light on the reflecting surfaces, respectively.

In planar view, the reflecting section 220 of the surface light source device disclosed in Patent Literature 2 sticks out of the light-emitting surface. This makes the rework (repair) process troublesome in the case of the surface light source device.

In contrast, according to the arrangement of the present invention, each of the first lightguide and the second lightguide has a reflecting surface formed in the light-emitting section so as to be located to interpose between the first lightguide section and the second lightguide section, and to divide the light-emitting surface into the first region and the second region, respectively; the first lightguide section and the second lightguide section are respectively provided on respective back sides with respect to the first region and the second region, and guide the light to the first region and the second region, respectively, by reflecting the light on the corresponding reflecting surface.

The arrangement makes it possible to dispose the first and second lightguide sections, the first and second light sources, and the first and second reflecting surfaces almost or completely within the first and second light-emitting surfaces in planer view. In addition, the arrangement makes it possible to secure a sufficient distance along the light guiding direction of each of the first and second lightguide sections (i.e., along the traveling direction of light emitted from each of the first and second light sources).

This makes it possible to adjacently dispose a plurality of illumination units so that any adjacent lightguides thereof do not overlap each other. In other words, it is possible to prevent such adjacent lightguides from interfering with each other in a rework process.

In a case where a specific lightguide and/or a specific light source has a failure after the illumination device is assembled from the plurality of illumination units, this makes it possible to replace only an illumination unit having the failure with a nondefective one in a rework process for replacing, with a nondefective one, an illumination unit having a failure. This makes it possible to carry out the rework process more efficiently, as compared to a tandem-type illumination device.

Therefore, the arrangement makes it possible to obtain the same effect as the tandem structure, and also increase ease of the rework process.

In other words, the arrangement makes it possible to realize an illumination unit which is slim, uniform in its light emission, and improved in ease of a rework process.

The illumination unit of the present invention is preferably arranged such that: the reflecting surface is perpendicular to the corresponding light-emitting surface.

The arrangement makes it possible to secure a large contact area between the first and second lightguides. As a result, this makes it possible to increase a connection strength therebetween.

The illumination unit of the present invention is preferably arranged such that: each of the reflecting surfaces is constituted by a reflecting member provided in the corresponding light-emitting section.

According to the arrangement, the first reflecting surface of the first lightguide and the second reflecting surface of the second lightguide are formed.

The illumination unit of the present invention is preferably arranged such that a shape of the first lightguide and a shape of the second lightguide are symmetrical to each other with respect to the reflecting surfaces.

The arrangement makes it possible to manufacture the first and second lightguides in a same manufacturing step. Specifically, the illumination unit can be realized by attaching the first and second lightguides to each other which have the same shape. This eliminates the need for different steps step for manufacturing the first and second lightguides.

The illumination unit of the present invention is preferably arranged such that: each of the first lightguide section and the second lightguide section is disposed so that its light guiding direction is inclined with respect to the corresponding light-emitting surface.

The arrangement allows the first lightguide section to uniformly emit the light from the first light source toward the first reflecting surface, and allows the second lightguide section to uniformly emit the light from the second light source toward the second reflecting surface. As a result, the reflected light from the first reflecting section is uniformly emitted via the first light-emitting surface, and the reflected light from the second reflecting section is uniformly emitted via the second light-emitting surface. This makes it possible to obtain further uniform surface light emission from each of the first and second light-emitting surfaces.

The illumination unit of the present invention is preferably arranged such that: each of the first lightguide section and the second lightguide section is disposed so that its light guiding direction is parallel with the corresponding light-emitting surface.

This makes it possible to further reduce a thickness of each of the first and second lightguides. This realizes slimming down of the illumination unit.

The illumination unit of the present invention is preferably arranged such that: each of the first lightguide section and the second lightguide section includes a light guiding direction changing section at a boundary between the lightguide section and the corresponding light-emitting section, the light guiding direction changing section changing the light guiding direction of the lightguide section.

A light guiding direction of the light emitted from the first light source is changed by the first light guiding direction changing section so that the light enters the first reflecting section. Similarly, a light guiding direction of the light emitted from the second light source is changed by the second light guiding direction changing section so that the light enters the second reflecting section. Therefore, the reflected light from the first reflecting section is uniformly emitted via the first light-emitting surface, and similarly, the reflected light from the second reflecting section is uniformly emitted via the second light-emitting surface. This makes it possible to obtain further uniform surface light emission from each of the first and second light-emitting surfaces. This makes it possible to provide an illumination unit which realizes both slimming down and uniformalization of light amounts.

The illumination unit of the present invention preferably includes a plurality of light diffusing means for diffusing light, the plurality of light diffusing means being provided on the light-emitting surfaces or on opposite surfaces of the light-emitting sections wherein the opposite surfaces are opposite sides of the light-emitting surfaces, the plurality of light diffusing means being disposed with a distribution density that is varied on the basis of an amount of light emission from the light-emitting surfaces.

Even if an in-plane distribution of amounts of light with which the first light-emitting surfaces is irradiated is nonuniform, the light diffusing means makes it possible to uniformalize the in-plane distribution. Similarly, even if an in-plane distribution of amounts of light with which the second light-emitting surfaces is irradiated is nonuniform, the light diffusing means makes it possible to uniformalize the in-plane distribution. This makes it possible to provide an illumination unit which performs further uniform surface light emission.

The illumination unit of the present invention is preferably arranged such that: the light-emitting sections respectively have a first opposite surface and a second opposite surface wherein the first opposite surface and second opposite surface are opposite sides of the first region and the second region, respectively, the first opposite surface is formed with an inclination so that a distance between the first opposite surface and the corresponding one of the light-emitting surfaces decreases with an increasing distance from the second light source, and the second opposite surface is formed with an inclination so that a distance between the second opposite surface and the corresponding one of the light-emitting surfaces decreases with an increasing distance from the first light source.

According to the arrangement, the light emitted from the first light source is reflected by the first reflecting surface, and further reflected by the first opposite surface. Similarly, the light emitted from the second light source is reflected by the second reflecting surface, and further reflected by the second opposite surface.

Thus, the first opposite surface makes it possible to further uniformly reflect the light from the first reflecting section toward the first light-emitting surface. Similarly, the second opposite surface makes it possible to further uniformly reflect the light from the second reflecting section toward the second light-emitting surface. This makes it possible to provide an illumination unit which performs further uniform surface light emission.

The illumination unit of the present invention is preferably arranged such that: the first light source and the second light source are point light sources, each of which is provided in a midpoint of width of the corresponding one of the first lightguide section and the second lightguide section, where the width of each of the first lightguide section and the second lightguide section is a dimension perpendicular to a length thereof along a light traveling direction from the first light source or the second light source to the corresponding light-emitting section, each of the first lightguide section and the second lightguide section satisfies the following formula:

$$X \geq \frac{L 1 \times n \sqrt{\{ 1 - ( 1 / {n}^{2} ) \}}}{2} \qquad [ Formula 1 ]$$

where: X is a distance, along the length of the corresponding one of the first lightguide section and the second lightguide section, between the corresponding one of the first light source and the second light source and the corresponding one of the light-emitting sections; L1 is a width dimension of the lightguide; and n is a refractive index of the lightguide.

According to the arrangement, a lower limit of the distance X is such a distance that on a boundary surface between the first light-emitting section and the first lightguide section, light entering from the first light source to the first lightguide section at a critical angle is expanded to both ends of the first lightguide section which both ends are located along the width direction of the first lightguide section, and similarly, on a boundary surface between the second light-emitting section and the second lightguide section, light entering from the second light source to the second lightguide section at the critical angle is expanded to both ends of the second lightguide section which both ends are located along the width direction of the second lightguide section. This makes it possible to expand, over the entire boundary surface between the first light-emitting section and the first lightguide section, the light entering from the first light source to the first lightguide section at the critical angle. Similarly, this makes it possible to expand, over the entire boundary surface between the second light-emitting section and the second lightguide section, the light entering from the second light source to the second lightguide section at the critical angle. The critical angle is determined depending on a refractive index of each of the first and second lightguide sections.

The illumination unit of the present invention is preferably arranged such that: each of the first light source and the second light source is a group of point light sources in which group a plurality of point light sources of respective different types corresponding respectively to different emission colors are arranged along width of the corresponding one of the first lightguide section and the second lightguide section, where the width of each of the first lightguide section and the second lightguide section is a dimension perpendicular to a length thereof along a light traveling direction from the first light source or the second light source to the corresponding light-emitting section; each of the first light source and the second light source is provided at a center of a length L1; and each of the first lightguide section and the second lightguide section satisfies the following formula:

$$X \geq \frac{( L 1 + L 2 ) n \sqrt{\{ 1 - ( 1 / {n}^{2} ) \}}}{2} \qquad [ Formula 2 ]$$

where: X is a distance, along the length of the corresponding one of the first lightguide section and the second lightguide section, between the corresponding one of the first light source and the second light source and the corresponding one of the light-emitting sections; L2 is a distance between a rightmost one of the plurality of point light sources and a leftmost one of the plurality of point light sources; L1 is a width dimension of the lightguide; and n is a refractive index of the lightguide.

According to the arrangement, a lower limit of the distance X is such a length that light entered at the critical angle into the first lightguide from a light source which is farthest from one end of the first lightguide reaches the one end, and similarly, light entered at the critical angle into the second lightguide from a light source which is farthest from one end of the second lightguide reaches the one end. This makes it possible to expand, over the entire boundary surface between the first light-emitting section and the first lightguide section, the light entered at the critical angle into the first lightguide from each of the plurality of light sources. Similarly, this makes it possible to expand, over the entire boundary surface between the second light-emitting section and the second lightguide section, the light entered at the critical angle into the second lightguide from each of the plurality of light sources. The critical angle is determined depending on a refractive index of each of the first and second lightguide sections.

Further, in a case where the plurality of light sources are, e.g., light-emitting diodes of respective different colors such as red (R), green (G), and blue (B), the arrangement makes it possible to prevent rays of light which have respective different colors from reaching the first and second light-emitting sections before the rays of light is uniformly mixed. This makes it possible to uniformly mix the rays of light which have respective different colors, on the boundary surface between the first light-emitting section and the first lightguide section and on the boundary surface between the second light-emitting section and the second lightguide section.

Therefore, the arrangement allows the first and second light-emitting surfaces to emit further uniform light in a case where the plurality of light sources are those of different types having respective different emission colors.

An illumination device of the present invention preferably includes the plurality of illumination units, the plurality of illumination units being planarly disposed.

The arrangement makes it possible to provide an illumination device improved in ease of a rework process.

The illumination device preferably includes the plurality of illumination units being planarly disposed, the plurality of illumination units being arrayed in such a manner that the illumination units are abutted with their adjacent illumination units at their portions at which the light-emitting surface and the opposite surface are closest, and spaces are formed below where the illumination units are abutted with their adjacent illumination units.

This makes it possible to provide, in the space: IC chips having certain heights such as a module and a driver; and wiring; etc. Thus, the arrangement improves flexibility of circuit design of a liquid crystal display apparatus, in designing a circuit of an illumination device, or in using the aforementioned illumination device as a backlight of the liquid crystal display apparatus.

The illumination device of the present invention is preferably arranged such that the plurality of illumination units are arrayed so that the spaces are connected with each other.

The arrangement makes it possible to convect, through the connected spaces, heat generated in the illumination device. In a case where the illumination device is provided as a backlight of a liquid crystal display apparatus, this makes it possible to convect, in the spaces, the heat generated in the liquid crystal display apparatus, so as to release the heat to the outside of the liquid crystal display apparatus. This makes it possible to realize an illumination device which can efficiently release heat generated inside a device to the outside thereof.

Further, it is preferable to provide, in the connected spaces, a member for heat release. This makes it possible to realize an illumination device which can convect the heat further efficiently.

A liquid crystal display apparatus preferably includes, as a backlight, any one of the illumination devices.

This makes it possible to provide a liquid crystal display apparatus improved in ease of a rework process.

### Advantageous Effects of Invention

As described above, an illumination unit of the present invention includes: a first lightguide and a second lightguide; a light-emitting surface made up of respective light-emitting surfaces of the first lightguide and the second lightguide; and a first light source and a second light source, being respectively provided on respective back sides with respect to the light-emitting surfaces, each of the first lightguide and the second lightguide including: a light-emitting section whose one surface is corresponding one of the light-emitting surfaces; corresponding one of a first lightguide section and a second lightguide section having (i) one end being connected to the corresponding one of the light-emitting sections and having (ii) other end serving as an incident surface of light emitted from the corresponding one of the first light source and the second light source respectively; and a reflecting surface formed in the light-emitting section so as to be located to interpose between the first lightguide section and the second lightguide section, and to divide the light-emitting surface into a first region and a second region, the first lightguide section and the second lightguide section being respectively provided on respective back sides with respect to the first region and the second region of the light-emitting surface and formed so as to guide the light to the first region and the second region by reflecting the light on the reflecting surfaces, respectively.

This makes it possible to realize an illumination unit which is slim, uniform in its light emission, and improved in ease of a rework process.

### BRIEF DESCRIPTION OF DRAWINGS

FIG. 1 is a perspective view illustrating an arrangement of a light-emitting unit constituting a backlight illustrated in FIG. 2.

FIG. 2 is a schematic view illustrating an arrangement of a liquid crystal display apparatus having a backlight of the present embodiment.

FIG. 3 is a plan view illustrating a lightguide section illustrated in FIG. 2.

FIG. 4

(a) of FIG. 4 is a plan view illustrating provision of a light diffusing measure to the light-emitting unit illustrated in FIG. 1. (b) is a side view corresponding to (a) of FIG. 4.

FIG. 5 is a side view illustrating a modification of the light-emitting unit illustrated in FIG. 1.

FIG. 6 is a schematic view illustrating an arrangement of a conventional side light-type illumination device.

FIG. 7 is a schematic view illustrating a backlight structure in which backlight devices are connected by a serial connection method.

### DESCRIPTION OF EMBODIMENTS

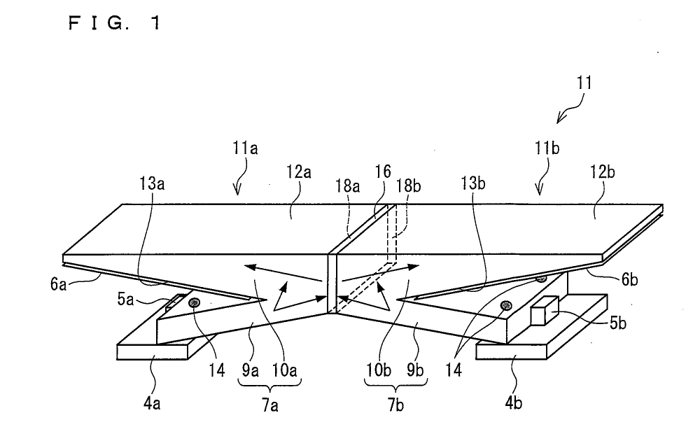

The following describes an embodiment of the present invention, with reference to FIGS. 1 to 5.

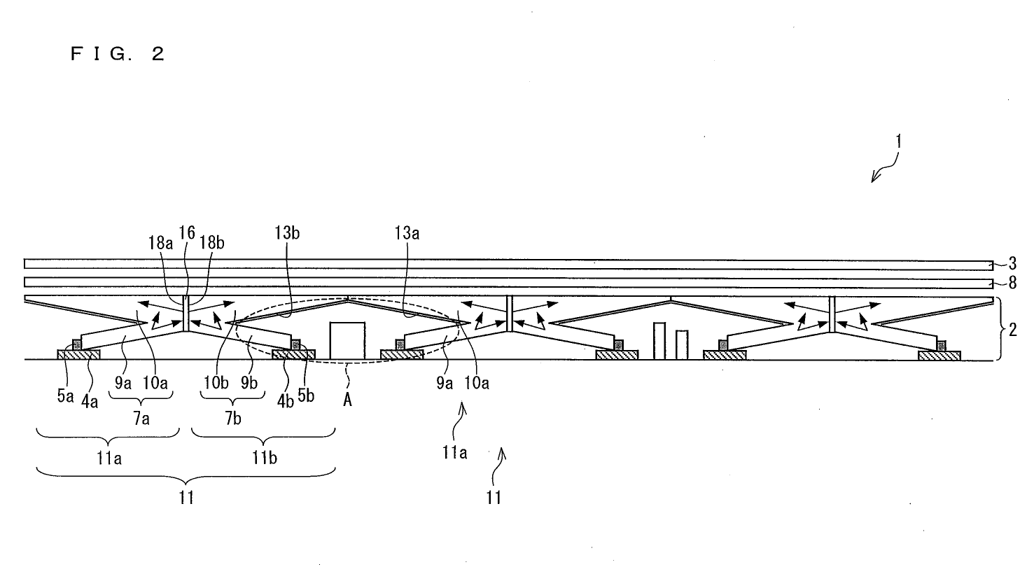

FIG. 2 is a schematic view illustrating an arrangement of that liquid crystal display apparatus of the present embodiment which has a backlight.

As illustrated in FIG. 2, a liquid crystal display apparatus 1 of the present embodiment includes: a liquid crystal display panel 3 (transmissive display panel); a backlight 2 (illumination device) provided behind the liquid crystal display panel 3; and an optical sheet 8 provided between the liquid crystal display panel 3 and the backlight 2.

The backlight 2 emits light toward the liquid crystal display panel 3 via the optical sheet 8. The liquid crystal display apparatus 1 is a transmissive liquid crystal display apparatus which displays an image by allowing the light from the backlight 2 to pass through the liquid crystal display panel 3.

An arrangement of the liquid crystal display panel 3 is not particularly limited in the present invention. Therefore, any publicly-known liquid crystal panel can be adopted as the liquid crystal display panel 3. Although the following arrangement is not illustrated, the liquid crystal display panel 3 includes: e.g., an active matrix substrate on which a plurality of TFTs (Thin Film Transistors) are formed; a color filter substrate facing the active matrix substrate; and a layer of liquid crystal sealed between the active matrix substrate and the color filter substrate by a seal material.

The following describes an arrangement of the backlight 2 provided in the liquid crystal display apparatus 1.

As illustrated in FIG. 2, the backlight 2 is provided behind the liquid crystal display panel 3 (i.e., provided on a counter side to a display surface). The backlight 2 includes a plurality of light-emitting units (illumination units) 11. Each of the light-emitting units 11 is made in such a manner that light-emitting units 11a and 11b are attached to each other via a reflecting member 16. The light-emitting unit 11a is a combination of a light source 5a and a lightguide 7a, and includes a reflecting surface 18a. Similarly, the light-emitting unit 11b is a combination of a light source 5b and a lightguide 7b, and includes a reflecting surface 18b. The light-emitting units 11 are provided on a substrate for a liquid crystal display apparatus.

The following describes details of the arrangement of a light-emitting unit 11, with reference to FIG. 1.

FIG. 1 is a perspective view illustrating an arrangement of a light-emitting unit 11 of the present embodiment.

In the light-emitting unit 11, light-emitting units 11a and 11b are arranged via a reflecting member 16.

The light-emitting unit 11a includes: a light source 5a; a reflecting surface (reflecting section) 18a for reflecting light from the light source 5a; a lightguide 7a (first lightguide) for diffusing the light from the light source 5a and the reflecting surface 18a and emitting the light in a surface-emitting manner; a base 4a on which the light source 5a is provided; a reflecting sheet 6a; etc.

The light-emitting unit 11b includes: a light source 5b; a reflecting surface (reflecting section) 18b for reflecting light from the light source 5b; a lightguide 7b (second lightguide) for diffusing the light from the light source 5b and the reflecting surface 18b and emitting the light in a surface-emitting manner; a base 4b on which the light source 5b is provided; a reflecting sheet 6b; etc.

The light-emitting unit 11 includes: the lightguide 7a having the light-emitting surface 12a (first region) for emitting light in a surface-emitting manner; the lightguide 7b having the light-emitting surface 12b (second region) for emitting light in a surface-emitting manner; the light source 5a (first light source) provided on a back side with respect to the light-emitting surface 12a; and the light source 5b (second light source) provided on a back side with respect to the light-emitting surface 12b.

The lightguide 7a includes: a light-emitting section 10a whose one surface is the light-emitting surface 12a; a lightguide section 9a whose one end is connected to the light-emitting section 10a and whose opposite end serves as an incident surface of the light from the light source 5a; and the reflecting surface 18a which is formed in the light-emitting section 10a so as to divide the light-emitting surface into the light-emitting surfaces 12a (first region) and 12b (second region) and so as to interpose between the lightguide sections 9a and 9b. Similarly, the lightguide 7b includes: a light-emitting section 10b whose one surface is the light-emitting surface 12b; a lightguide section 9b whose one end is connected to the light-emitting section 10b and whose opposite end is an incident surface of the light from the light source 5b; and the reflecting surface 18b which is formed in the light-emitting section 10b so as to divide the light-emitting surface into the light-emitting surfaces 12a (first region) and 12b (second region) and so as to interpose between the lightguide sections 9a and 9b.

The light-emitting surface 12a receives the light from the light source 5a so as to emit the light in the surface-emitting manner. Similarly, the light-emitting surface 12b receives the light from the light source 5b so as to emit the light in the surface-emitting manner.

The lightguide section 9a is provided on the back side with respect to the light-emitting surface 12a. Similarly, the lightguide section 9b is provided on the back side with respect to the light-emitting surface 12b. The lightguide section 9a is formed so that the light is reflected on the reflecting surface 18a toward the light-emitting surface 12a. The lightguide section 9a is disposed so that its light guiding direction is tilted with respect to the light-emitting surface 12a. An upper surface of the lightguide section 9a (i.e., surface on a light-emitting surface 12a side) is connected with an opposite surface 13a (first opposite surface) opposite to the light-emitting surface 12a. The opposite surface 13a is formed with an inclination so that a distance between the opposite surface 13a and the light-emitting surface 12a increases from one side of the opposite surface 13a where the opposite surface 13a and the light-emitting surface 12a are connected toward a center (i.e., the other side of the opposite surface 13a where the opposite surface 13a and the upper surface of the lightguide section 9a are connected).

That is, the opposite surface 13a is formed with an inclination so that the distance between the opposite surface 13a and the light-emitting surface 12a decreases with an increasing distance from the light source 5b.

The lightguide section 9b is formed so that the light is reflected on the reflecting surface 18b toward the light-emitting surface 12b. The lightguide section 9b is disposed so that its light guiding direction is tilted with respect to the light-emitting surface 12b. An upper surface of the lightguide section 9b (i.e., surface on a light-emitting surface 12b side) is connected with an opposite surface 13b (second opposite surface) opposite to the light-emitting surface 12b. The opposite surface 13b is formed with an inclination so that a distance between the opposite surface 13b and the light-emitting surface 12b increases from one end of the opposite surface 13b where the opposite surface 13b and the light-emitting surface 12b are connected toward a center side (i.e., the other end of the opposite surface 13b where the opposite surface 13b and the upper surface of the lightguide section 9b are connected).

That is, the opposite surface 13b is formed with an inclination so that the distance between the opposite surface 13a and the light-emitting surface 12a decreases with an increasing distance from the light source 5b.

The arrangement makes it possible to dispose the lightguide sections 9a and 9b, the light sources 5a and 5b, and the reflecting surfaces 18a and 18b almost or completely within the light-emitting surfaces 12a and 12b in planer view. In addition, the arrangement makes it possible to secure a sufficient distance along the light guiding direction of each of the lightguide sections 9a and 9b.

This makes it possible to adjacently dispose a plurality of light-emitting units 11 so that any adjacent lightguides thereof do not overlap each other. In other words, it is possible to prevent such adjacent lightguides from interfering with each other.

In a case where a specific lightguide has a failure after the backlight 2 is assembled from the plurality of light-emitting units 11, this makes it possible to replace only a light-emitting unit 11 having the failure with a nondefective one in a rework process for replacing, with a nondefective one, a light-emitting unit 11 having a failure.

This makes it possible to carry out the rework process more efficiently, as compared to the case of a conventional tandem-type illumination device in which adjacent lightguides are disposed so as to overlap each other.

Therefore, the light-emitting unit 11 of the present embodiment makes it possible to realize a backlight which makes it possible to obtain the same effect as the conventional tandem structure, and also carry out the rework process efficiently. In other words, the light-emitting unit 11 makes it possible to realize the backlight 2 which is slim, uniform in its light emission, and improved in ease of a rework process.

By use of fixing members 14 such as screws and pins, the lightguide 7a is fixed to the base 4a and to a liquid crystal display apparatus driving substrate (not illustrated) etc. which are provided below the base 4a. Specifically, the lightguide 7a is fixed thereto at two points of the lightguide section 9a near that one end of the lightguide section 9a which is closer to the light source 5a than the other end. Similarly, by use of the fixing members 14, the lightguide 7b is fixed to the base 4b and to the liquid crystal display apparatus driving substrate (not illustrated) etc. which are provided below the base 4b. Specifically, the lightguide 7b is fixed thereto at two points of the lightguide section 9b near that one end of the lightguide section 9b which is closer to the light source 5b than the other end.

The light (pencil of light) emitted from the light source 5a which is a point source radiates at a critical angle θ in the lightguide section 9a (to be described later in detail). Similarly, the light (pencil of light) emitted from the light source 5b which is a point light source radiates at the critical angle θ in the lightguide section 9b (to be described later in detail). Therefore, the light emitted from the light-emitting surface 12a is not affected by the fixing members 14 even though as illustrated in FIG. 1, the fixing members 14 are provided at the two points of one end portion of the lightguide section 9a which two points are located near both ends of the one end portion in the width direction of the lightguide section 9a and which one end portion is closer to the light source 5a than the other end portion. Similarly, the light emitted from the light-emitting surface 12b is not affected by the fixing members 14 even though as illustrated in FIG. 1, the fixing members 14 are provided at the two points of one end portion of the lightguide section 9b which two points are located near both ends of the one end portion in the width direction of the lightguide section 9b and which one end portion is closer to the light source 5b than the other end portion.

Each of the light sources 5a and 5b is a point-like light source such as a light-emitting diode (LED). According to the present embodiment, each of the light sources 5a and 5b is made up of light-emitting diodes of different types having respective different emission colors. Specifically, each of the light sources 5a and 5b is a group of LEDs in which group at least three light-emitting diodes corresponding respectively to the three colors: red (R); green (G); and blue (B) are arranged. Thus, each of the light sources 5a and 5b is realized by combining the light-emitting diodes of the three colors. This allows the light-emitting surfaces 11a and 11b to emit white light.

How colors of light-emitting diodes are combined can be determined on the basis of chromogenic characteristics of light-emitting diodes of respective different colors and that chromogenic characteristic of the backlight 2 of the liquid crystal display apparatus 1 which is required as to a purpose of use thereof. The light sources 5a and 5b are mounted on the bases 4a and 4b, respectively. Instead of such light-emitting diodes, a side-light-type LED can be adopted as each of the light sources 5a and 5b. The side-light-type LED is made by molding LED chips of respective different colors into one package. This makes it possible to obtain a backlight having a wide color reproduction range. Alternatively, each of the light sources 5a and 5b can be realized by one light-emitting diode of white so as to emit white light.

The light source 5a is provided to that one end portion of the lightguide section 9a which is more distant from the reflecting surface 18a than the other end portion. Similarly, the light source 5b is provided to that one end portion of the lightguide section 9b which is more distant from the reflecting surface 18b than the other end portion.

Respective surfaces (i.e., light-emitting surfaces 12a and 12b) or the opposite surfaces 13a and 13b of the light-emitting sections 10a and 10b of the lightguides 7a and 7b are processed and/or treated so as to emit the guided light frontward. This makes it possible to efficiently emit light from the light-emitting surfaces 12a and 12b toward the liquid crystal display panel 3. Examples of the processing and treatment for respective surfaces (light-emitting surfaces 12a and 12b) of the light-emitting sections 10a and 10b of the lightguides 7a and 7b encompass prism processing, texturing, and print processing. However, processing and/or treatment for the surfaces is not particularly limited to this, but can be any publicly known processing and/or treatment for causing light to be emitted from a light-emitting surface.

The lightguides 7a and 7b are made from a transparent resin such as polycarbonate (PC) and polymethylmethacrylate (PMMA). However, the lightguides 7a and 7b can be made from a material which is commonly used as a material for a lightguide. The lightguides 7a and 7b can be formed by a method using a molding die such as injection molding, extrusion molding, and heat-press molding. However, a method for forming the lightguides 7a and 7b is not limited to this, but can be any method, provided that the lightguides 7a and 7b can have a characteristic similar to one realized by the aforementioned methods.

The reflecting member 16 is for providing (i) the reflecting surface 18a for optically connecting the light-emitting section 10a and the lightguide 9a of the lightguide 7a and (ii) the reflecting surface 18b for optically connecting the light-emitting section 10b and the lightguide 9b of the lightguide 7b. The reflecting surface 18a is disposed so as to make a right angle with one end portion of the light-emitting surface 12a. Similarly, the reflecting surface 18b is disposed so as to make a right angle with one end portion of the light-emitting surface 12b. This makes it possible to secure a large contact area between the lightguides 9a and 9b. As a result, this makes it possible to increase a contact strength between the lightguides 9a and 9b.

The reflecting member 16 is provided between respective attachment surfaces (reflecting surfaces 18a and 18b) of the opposed lightguides 7a and 7b. The reflecting member 16 is made by performing mirror-like finishing of the attachment surfaces. Examples of a material of the reflecting member 16 encompass silver having a high reflectivity. A material for the reflecting member 16 is not limited to silver, but can be any material, provided that a required reflectivity can be obtained.

The reflecting member 16 is formed in the following manner for example. First, the lightguides 7a and 7b are formed from a transparent resin by use of a molding die. Then, silver is evaporated onto the attachment surfaces (reflecting surfaces 18a and 18b) of the lightguides 7a and 7b. Finally, the attachment surfaces onto which the silver has been evaporated are bonded to each other by use of an adhesive. Thus, the reflecting member 16 is formed between the reflecting surfaces 18a and 18b.

Alternatively, the reflecting member 16 can be formed between the reflecting surfaces 18a and 18b in such a manner that a reflecting sheet is attached onto each of the attachment surfaces (reflecting surfaces 18a and 18b), and then, the attachment surfaces onto each of which the reflecting sheet has been attached are bonded to each other by an adhesive.

A method for forming the reflecting member 16 and a method for bonding the lightguides 7a and 7b to each other are not limited to the aforementioned methods, but can be any methods, provided that the reflecting member 16 and the lightguides 7a and 7b can have characteristics similar to those realized by the aforementioned methods.

Thus, the reflecting member 16 is formed between the reflecting surfaces 18a and 18b which are opposite to each other and have a planer shape, and the lightguides 7a and 7b are bonded to each other.

According to the arrangement, the light emitted from the light source 5a is reflected inside the lightguide section 9a, and further reflected on the reflecting surface 18a so as to enter the light-emitting section 10. Similarly, the light emitted from the light source 5b is reflected inside the lightguide section 9b, and further reflected on the reflecting surface 18b so as to enter the light-emitting section 10. Then, the light in the light-emitting section 10a is emitted from the light-emitting surface 12a in the surface-emitting manner. Similarly, the light in the light-emitting section 10b is emitted from the light-emitting surface 12b in the surface-emitting manner. Accordingly, the light emitted from the light source 5a and the light emitted from the light source 5b indirectly reach the light-emitting surfaces 12a and 12b, respectively. In other words, the light emitted from the light source 5a and the light emitted from the light source 5b do not directly reach the light-emitting surfaces 12a and 12b, respectively. This realizes uniform surface light emission on the light-emitting surfaces 12a and 12b.

It is preferable that the upper surface (surface on the light-emitting surface 12 side) of each of the lightguide sections 9a and 9b and the lower surface thereof which is opposite to the upper surface be disposed parallel with each other or disposed so as to open toward the light emission direction. This makes it possible to totally reflect the light from the light sources 5a and 5b. As a result, the light can be guided to the light-emitting sections 10a and 10b.

The base 4a is for mounting the light source 5a thereon, and the base 4b is for mounting the light source 5b thereon. For improvement of luminance, the bases 4a and 4b are preferably while ones. Mounted on the back surface (surface opposite to the surface on which the light source 5a is mounted) of the base 4a is a driver (not illustrated) for controlling lighting of the LEDs of the light source 5a. Similarly, mounted on the back surface (surface opposite to the surface on which the light source 5b is mounted) of the base 4b is a driver (not illustrated) for controlling lighting of the LEDs of the light source 5b. Thus, the drivers are mounted on the bases 4a and 4b on which the light sources 5a and 5b are mounted. This makes it possible to reduce the number of bases, and reduce connecters or the like for connecting the bases. This realizes a low-cost device. Further, this realizes slimming down of the backlight 2 because less bases are required.

The reflection sheets 6a and 6b are provided so as to have contact with the opposite surfaces 13a and 13b, respectively. The reflecting sheets 6a and 6b are for reflecting light so that the light is efficiently emitted from the light-emitting surfaces 12a and 12b. By providing the reflecting sheet 6a and 6b to the opposite surfaces 13a and 13b, it becomes possible to prevent the light emitted from the light source 5a except that part of the light which enters the lightguide section 9a from directly entering the light-emitting section 10a via the opposite surface 13a, and to similarly prevent the light emitted from the light source 5b except that part of the light which enters the lightguide section 9b from directly entering the light-emitting section 10b via the opposite surface 13b. In other words, by providing the reflecting sheet 6a and 6b to the opposite surfaces 13a and 13b, it becomes possible to block, by the reflecting sheet 6a, the light from the light source 5a so that the light cannot enter the light-emitting section 10a via the opposite surface 13a, and to similarly block, by the reflecting sheet 6b, the light from the light source 5b so that the light cannot enter the light-emitting section 10b via the opposite surface 13b.

In the backlight 2 of the present embodiment, a plurality of light-emitting units 11 thus arranged are provided together so as to be disposed in, e.g., a matrix pattern. Specifically, an illumination area of the backlight 2 is divided into areas corresponding respectively to the plurality of light-emitting units 11a and the plurality of light-emitting units 11b.

Further, as described above, the optical sheet 8 is provided on a construction in which the plurality of light-emitting units 11 are disposed. The optical sheet 8 is realized by adopting any one of the following or by combining at least two of the following: a diffusing plate for irradiating the liquid crystal display panel 3 with uniform light; a diffusing sheet for converging and scattering light; a lens sheet for converging light so as to increase a frontward luminance; and a polarized light reflecting sheet for reflecting one polarization component and allowing the other polarization component to pass through the polarized light reflecting sheet, so as to increase a luminance of the liquid crystal display apparatus 1. How the optical sheet 8 is arranged is determined by a price and performance of the liquid crystal display apparatus 1.

According to the arrangement, the light emitted from the light source 5a which is a point-like light source is subjected to scattering and reflection while traveling inside the lightguide 7a, so as to be emitted from the light-emitting surface 12a. The same holds for the light emitted from the light source 5b. In FIGS. 1 and 2, arrows indicate traveling directions of light.

Then, the light emitted from the light-emitting surfaces 12a and 12b is diffused by the optical sheet 8 provided on the frontal surfaces of the lightguides 7a and 7b. Thus, the light is uniformalized and converged so that the liquid crystal display panel 3 is irradiated with the light.

A luminance of each of the plurality of light-emitting units 11a and 11b can be independently controlled. By individually controlling respective luminances of the plurality of light-emitting units 11a and 11b, it becomes possible to perform area-active control of the illumination area of the backlight 2. As a result, the liquid crystal display apparatus 1 can display a high-contrast image.

(Length of Lightguide Section Along Emission Direction)

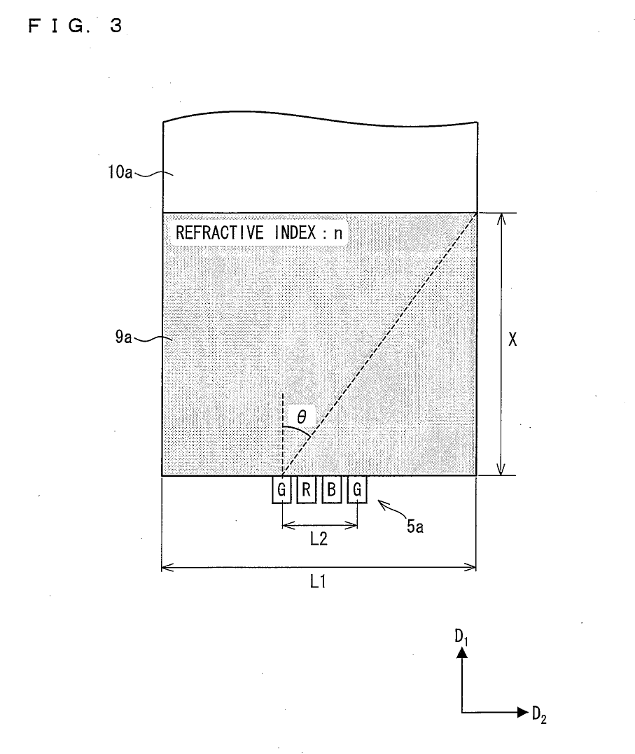

In a case where as in the case of the backlight 2 of the present embodiment, each of the light sources 5a and 5b is a group of LEDs in which group at least three light-emitting diodes corresponding respectively to the three colors: red (R), green (G), and blue (B) are arranged, the lightguide section 9a and 9b serve as color mixing areas for mixing the three colors so that white light is emitted from the light-emitting surface 12. In a case where each of the lightguide sections 9a and 9b (color mixing areas) is short in length in such a backlight 2, rays of light which respectively have the three colors are not completely mixed, but separate rays of light corresponding respectively to the three colors are emitted from each of the light-emitting surfaces 12a and 12b. This causes luminance unevenness. The following describes the length of the lightguide sections 9a and 9b, with reference to FIG. 3. Although the following deals with the lightguide section 9a only, the same holds for the lightguide section 9b. FIG. 3 is a plan view of the lightguide section 9a.

The following example assumes that the light source 5a is a group of LEDs made up of a green LED (G-LED), a red LED (R-LED), a blue LED (B-LED), and a green LED (G-LED), and provided to the lightguide section 9a is one such light source 5a.

In a case where as in the case of the backlight 2 of the present embodiment, the light source 5a which is a point-like light source and the lightguide 7a are combined, a pencil of light emitted from the light source 5a radiates at a critical angle θ in the lightguide section 9a. The critical angle θ is determined by a refractive index “n” of a material from which the lightguide 7a is made. That is, the lightguide section 9a plays a role in sufficiently expanding, before the pencil of light which has entered the lightguide 7 at a critical angle θ reaches the light-emitting section 10a, the pencil of light.

Assume that the refractive index of the lightguide 7a is “n.” By Snell's law, light which has entered the lightguide 7a from that airspace outside the lightguide 7a in which the light source 5a is provided has a refraction angle smaller than the critical angle θ.

In order to cause the light entering from the light source 5a to the lightguide 7a to reach the entire boundary surface between the light-emitting section 10a and the lightguide section 9a, it is necessary that the light entering from the light source 5a to the lightguide 7a at the critical angle θ reach both ends of the lightguide 7a in the lightguide section 9a which both ends are located along the width direction D2 of the lightguide 7a.

A lower limit of a distance X satisfying such a condition is such a distance that light entered at the critical angle into the lightguide 7a from that one of the plurality of LEDs constituting the light source 5a which is farthest from one of the both ends of the lightguide 7a reaches the one of the both ends. In other words, the lower limit of the distance X is such a distance that light entered into the lightguide 7a at the critical angle θ from the leftmost LED in FIG. 3 (i.e., G-LED) reaches one end of the lightguide 7a on the boundary surface between the light-emitting section 10a and the lightguide section 9a, as indicated with the dashed line.

The lower limit X of the distance X satisfies the following equation (a).

tan θ={(L1+L2)/2}/X=(L1+L2)/2X (a)

By Snell's law, the following equation (b) can be obtained.

sin θ=1/n (b)

Further, the following equation (c) can be obtained from a formula of a trigonometric function.

$$\begin{matrix}[ Formula 3 ] & \\ tan θ = \frac{sin θ}{\sqrt{( 1 - {sin}^{2} θ )}} & ( c )\end{matrix}$$

The lower limit of the distance X satisfies the following equation (d) which is obtained from the equations (a) to (c).

$$\begin{matrix}[ Formula 4 ] & \\ ( L 1 + L 2 ) / 2 X = \frac{1}{n \sqrt{\{ 1 - 1 ( 1 / {n}^{2} ) \}}} \\ X = \frac{( L 1 + L 2 ) n \sqrt{\{ 1 - ( 1 / {n}^{2} ) \}}}{2} & ( d )\end{matrix}$$

Therefore, the distance X preferably satisfies the following equation (1).

$$\begin{matrix}[ Formula 5 ] & \\ X \geq \frac{( L 1 + L 2 ) n \sqrt{\{ 1 - ( 1 / {n}^{2} ) \}}}{2} & ( 1 )\end{matrix}$$

In a case where the following equation (1) is satisfied, the light source 5a is located in the midpoint of that length L1 of each of the lightguides 7a which is parallel with the width direction D2 of the lightguide 7a. This makes it possible to set the distance X of the lightguide section 9a to a smaller value, as compared to an arrangement in which the light source 5a is located, along the width direction D2, closer to either end of the lightguide 7a

The backlight 2, which is made by combining the light-emitting units 11 in each of which the aforementioned light-emitting units 11a and 11b are attached via a reflecting member 16 makes it possible to expand, over the entire boundary surface between the light-emitting section and the lightguide section, light emitted at the critical angle from each of the plurality of light sources into a corresponding one of the lightguides. Further, in a case where each of the light sources is made up of light-emitting diodes of respective different colors, the backlight 2 makes it possible to prevent rays of light which have respective different colors from reaching the light-emitting section before the rays of light is uniformly mixed. This makes it possible to uniformly mix the rays of light which have respective different colors, on the boundary surface between the light-emitting section and the lightguide section.

In a case where the light source 5a is realized by one white LED, L2=0 is satisfied. Therefore, it is preferable to satisfy the following equation (2).

$$\begin{matrix}[ Formula 6 ] & \\ X \geq \frac{L 1 \times n \sqrt{\{ 1 - ( 1 / {n}^{2} ) \}}}{2} & ( 2 )\end{matrix}$$

As illustrated in FIG. 2, the backlight 2 of the present embodiment has a space A in the vicinity of each place where two adjacent light-emitting units 11 are abutted with each other.

Specifically, in the backlight 2, the plurality of light-emitting units 11 are planarly disposed, and the light-emitting units 11 are arrayed in a line in such a manner that any two adjacent light-emitting units 11 are abutted with each other at their portions at which a distance between the light-emitting surfaces 12a and 12b and the opposite surfaces 13a and 13b is shortest. The space A is formed below where the light-emitting units 11 are abutted with each other.

The space A is a space formed so as to be surrounded by (i) the opposite surface 13a of the light-emitting section 10a of a light-emitting unit 11a, (ii) the lightguide section 9a of the light-emitting unit 11a, (iii) the opposite surface 13b of the light-emitting section 10b of an adjacent light-emitting unit 11b, and (iv) the lightguide section 9b of the adjacent light-emitting unit 11b. The space A makes it possible to provide therein: a driver for driving the liquid crystal display apparatus 1; IC chips having certain heights such as a module; wiring; etc. Concrete examples encompass a thermistor for temperature measurement, a photosensor for measuring the degree of deterioration of an LED, and a driver for driving LEDs which driver can control lighting of the plurality of LEDs of each of the light sources 5a and 5b.

Thus, the space A is formed according to the arrangement of the backlight 2 of the present embodiment. This improves flexibility of circuit design of the liquid crystal display apparatus 1.

Further, the plurality of light-emitting units 11 are disposed so that the spaces A are penetrable from the top to the bottom of the liquid crystal display apparatus 1 in a usable state thereof. This makes it possible to convect, in the spaces A, heat generated from the circuit of the liquid crystal display apparatus 1, so as to release the heat to the outside of the liquid crystal display apparatus 1. Therefore, the arrangement of the backlight 2 of the present embodiment makes it possible to efficiently release such heat to the outside of the liquid crystal display apparatus 1.

Further, a member for heat release such as a heat pipe is provided in each of the spaces A. This makes it possible to release such heat to the outside of the liquid crystal display apparatus 1 further efficiently.

(Disposition of Light-Diffusing Measure)

The backlight 2 of the present embodiment can have a plurality of prisms 15 (light-diffusing measure) for diffusing light, on each of the light-emitting surfaces 12a and 12b (i.e., surfaces on the liquid crystal display panel 3 side) or the opposite surfaces 13a and 13b.

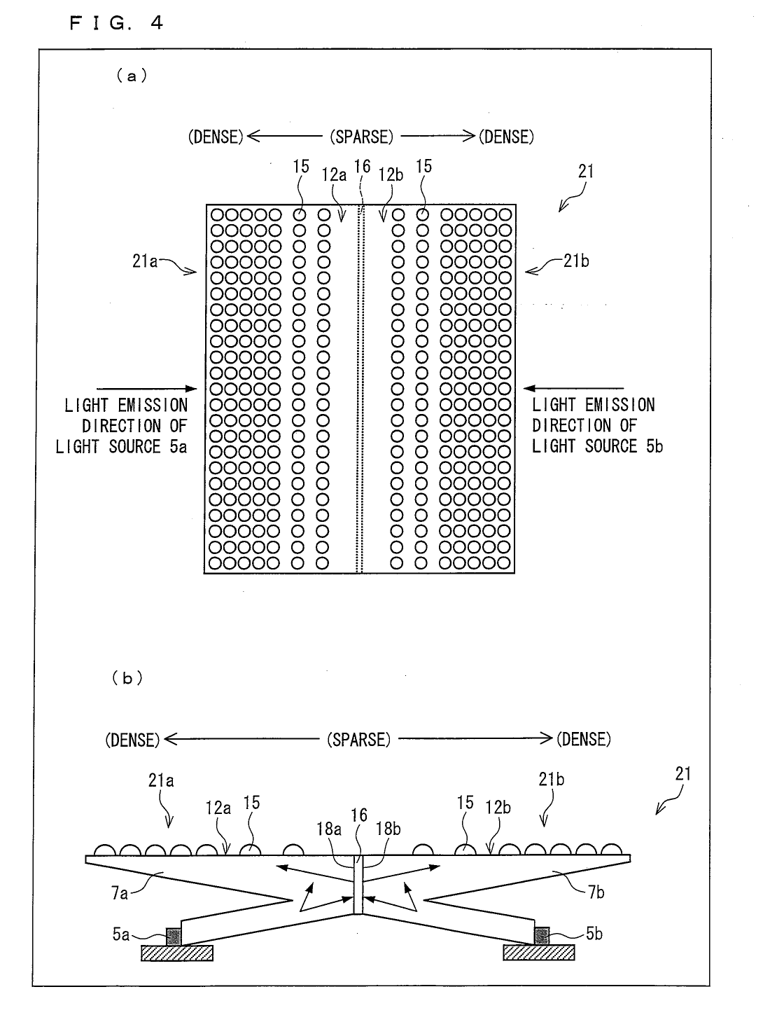

The following describes this, with reference to (a) and (b) of FIG. 4.

(a) of FIG. 4 is a plan view illustrating a light-emitting unit of the present embodiment. (b) of FIG. 4 is a side view corresponding to (a) of FIG. 4.

As illustrated in (a) and (b) of FIG. 4, the light-emitting unit 21 is made by attaching the light-emitting units 21a and 21b via the reflecting member 16. The light-emitting unit 21a has a plurality of prisms on the light-emitting surface 12a as a light-diffusing measure. The same holds for the light-emitting unit 21b. Except for this, the light-emitting units 21a and 21b are arranged in the same way as the light-emitting units 11a and 11b.

For example, as illustrated in (a) and (b) of FIG. 4, the prisms 15 are arranged so that a distribution density of the prisms 15 varies from sparse to dense as a distance from the reflecting surfaces 18a and 18b increases.

Thus, the prisms 15 are disposed so as to be high in distribution density in an area on the light-emitting surface 12 where a small amount of light is emitted in the surface-emitting manner. In contrast, the prisms 15 are disposed so as to be low in distribution density in an area on the light-emitting surface 12 where a large amount of light is emitted in the surface-emitting manner. Thus, the plurality of prisms 15 are disposed on the light-emitting surface 12 so that an in-plane distribution of amounts of light emitted from the light-emitting surface 12 in the surface-emitting manner is uniform.

A distribution density of the prisms 15 is determined on the basis of an amount of light emission from the light-emitting surfaces 12a and 12b of the lightguides 7a and 7b. Therefore, how the prisms 15 are disposed is not particularly limited.

Thus, the prisms 15 are provided on the light-emitting surfaces 12a and 12b as a light-diffusing measure. This makes it possible to further increase uniformity of luminance of the backlight 2.

The light-diffusing measure is not limited to a prism. It is possible to adopt those which are conventionally adopted as a light-diffusing member of an illumination device, such as minute projections and depressions (grain pattern or the like), and a printed dot pattern.

(Modification)

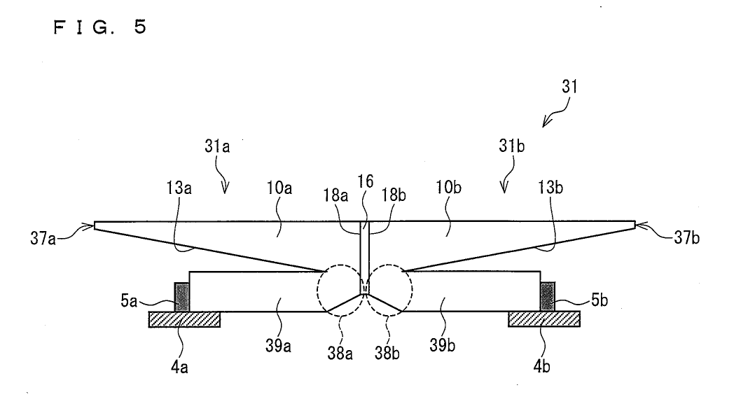

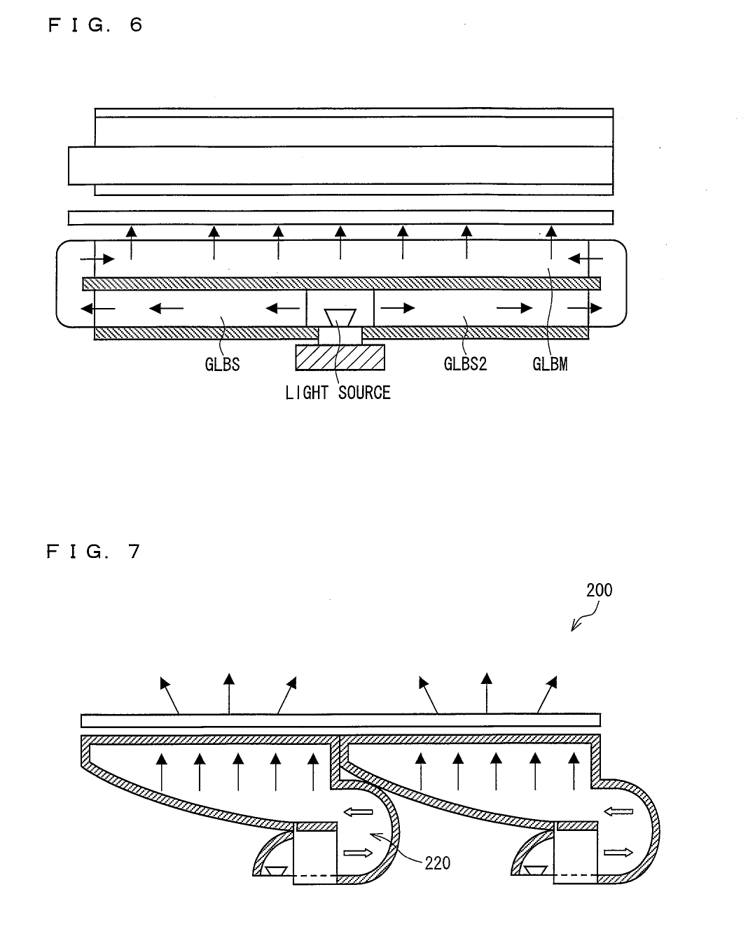

The following describes a modification of the light-emitting unit 11, with reference to FIG. 5.

FIG. 5 is a side view illustrating the modification of the light-emitting unit 11 of the present embodiment.

A light-emitting unit 31 is made by attaching light-emitting units 31a and 31b via a reflecting member 16. The light-emitting units 31a and 31b are different from the light-emitting units 11a and 11b in contact angle between the light-emitting section and the lightguide section.

As illustrated in FIG. 5, a lightguide 37a includes a light-emitting section 10a (light-emitting section) having a light-emitting surface 12a, a lightguide section 39a (lightguide section) for guiding light from a light source 5a to the light-emitting section 10a, and a reflecting surface 18a (light guiding direction changing section) for reflecting light from the lightguide section 39a to the light-emitting section 10.

Similarly, a lightguide 37b includes a light-emitting section 10b (light-emitting section) having a light-emitting surface 12b, a lightguide section 39b (lightguide section) for guiding light from a light source 5b to the light-emitting section 10b, and a reflecting surface 18b (light guiding direction changing section) for reflecting light from the lightguide section 39b to the light-emitting section 10b.

The lightguide section 39a includes connecting areas 38a and 38b. The lightguide sections 39a and 39b are disposed so that their light guiding directions is parallel with the light-emitting surfaces 12a and 12b. The connecting area 38a is provided in the vicinity of the boundary between the lightguide section 39a and the reflecting surface 18a. Similarly, the connecting area 38b is provided in the vicinity of the boundary between the lightguide section 39b and the reflecting surface 18b. A bottom surface of the connecting area 38a is disposed so that an end of the bottom surface which end has contact with the reflecting surface 18a is inclined toward the light-emitting surface 12a. The same holds for a bottom surface of the connecting area 38b.

Thus, the light guiding directions of the lightguide sections 39a and 39b are set parallel with the light-emitting surfaces 12a and 12b. The light-emitting unit 31 can have a smaller thickness, as compared to the light-emitting unit 11. This makes it possible to realize a small thickness of the backlight 2. This realizes slimming down of the liquid crystal display apparatus 1.

The invention being thus described, it will be obvious that the same way may be varied in many ways. Such variations are not to be regarded as a departure from the spirit and scope of the invention, and all such modifications as would be obvious to one skilled in the art are intended to be included within the scope of the following claims.

### INDUSTRIAL APPLICABILITY

The present invention makes it possible to provide an illumination device whose light source uniformly emits light and which is improved in ease of a rework process, without being decreased in its strength. The illumination device of the present invention can be used as a backlight of a liquid crystal display apparatus.

### REFERENCE SIGNS LIST

1 Liquid crystal display apparatus
2 Backlight (illumination device)
3 Liquid crystal display panel (transmissive display panel)
4a and 4b Base
5a Light source (first light source)
5b Light source (second light source)
6a and 6b Reflecting sheet
7a Lightguide (first lightguide)
7b Lightguide (second lightguide)
8 Optical sheet
9a Lightguide section (first lightguide section)
9b Lightguide section (second lightguide section)
10a and 10b Light-emitting section
11 Light-emitting unit (illumination unit)
11a and 11b Light-emitting unit
12a Light-emitting surface (first region)
12b Light-emitting surface (second region)
13a Opposite surface (first opposite surface)
13b Opposite surface (second opposite surface)
14 Fixing member
15 Prism (light diffusing measure)
21 Light-emitting unit (illumination unit)
31 Light-emitting unit (Illumination unit)
37a Lightguide (first lightguide)
37b Lightguide (second lightguide)
38a and 38b Connecting area (light guiding direction changing section)
39a Lightguide section (first lightguide section)
39b Lightguide section (second lightguide section)

1. An illumination unit for use as a backlight of a transmissive display panel, comprising:
a first lightguide and a second lightguide;
a light-emitting surface made up of respective light-emitting surfaces of the first lightguide and the second lightguide; and
a first light source and a second light source, being respectively provided on respective back sides with respect to the light-emitting surfaces,
each of the first lightguide and the second lightguide including:
a light-emitting section whose one surface is corresponding one of the light-emitting surfaces;
corresponding one of a first lightguide section and a second lightguide section having (i) one end being connected to the corresponding one of the light-emitting sections and having (ii) other end serving as an incident surface of light emitted from the corresponding one of the first light source and the second light source respectively; and
a reflecting surface formed in the light-emitting section so as to be located to interpose between the first lightguide section and the second lightguide section, and to divide the light-emitting surface into a first region and a second region,
the first lightguide section and the second lightguide section being respectively provided on respective back sides with respect to the first region and the second region of the light-emitting surface and formed so as to guide the light to the first region and the second region by reflecting the light on the reflecting surfaces, respectively.

2. The illumination unit as set forth in claim 1, wherein:
the reflecting surface is perpendicular to the corresponding light-emitting surface.

3. The illumination unit as set forth in claim 1, wherein:
each of the reflecting surfaces is constituted by a reflecting member provided in the corresponding light-emitting section.

4. The illumination unit as set forth in claim 1, wherein a shape of the first lightguide and a shape of the second lightguide are symmetrical to each other with respect to the reflecting surfaces.

5. The illumination unit as set forth in claim 1, wherein:
each of the first lightguide section and the second lightguide section is disposed so that its light guiding direction is inclined with respect to the corresponding light-emitting surface.

6. The illumination unit as set forth in claim 1, wherein:
each of the first lightguide section and the second lightguide section is disposed so that its light guiding direction is parallel with the corresponding light-emitting surface.

7. The illumination unit as set forth in claim 6, wherein:
each of the first lightguide section and the second lightguide section includes a light guiding direction changing section at a boundary between the lightguide section and the corresponding light-emitting section, the light guiding direction changing section changing the light guiding direction of the lightguide section.

8. The illumination unit as set forth in claim 1, comprising:
a plurality of light diffusing means for diffusing light, the plurality of light diffusing means being provided on the light-emitting surfaces or on opposite surfaces of the light-emitting sections wherein the opposite surfaces are opposite sides of the light-emitting surfaces,
the plurality of light diffusing means being disposed with a distribution density that is varied on the basis of an amount of light emission from the light-emitting surfaces.

9. The illumination unit as set forth in claim 1, wherein:
the light-emitting sections respectively have a first opposite surface and a second opposite surface wherein the first opposite surface and second opposite surface are opposite sides of the first region and the second region, respectively,
the first opposite surface is formed with an inclination so that a distance between the first opposite surface and the corresponding one of the light-emitting surfaces decreases with an increasing distance from the second light source, and
the second opposite surface is formed with an inclination so that a distance between the second opposite surface and the corresponding one of the light-emitting surfaces decreases with an increasing distance from the first light source.

10. The illumination unit as set forth in claim 1, wherein:
the first light source and the second light source are point light sources, each of which is provided in a midpoint of width of the corresponding one of the first lightguide section and the second lightguide section, where the width of each of the first lightguide section and the second lightguide section is a dimension perpendicular to a length thereof along a light traveling direction from the first light source or the second light source to the corresponding light-emitting section,
each of the first lightguide section and the second lightguide section satisfies the following formula:
$$X \geq \frac{L 1 \times n \sqrt{\{ 1 - ( 1 / {n}^{2} ) \}}}{2} \qquad [ Formula 1 ]$$
where:
X is a distance, along the length of the corresponding one of the first lightguide section and the second lightguide section, between the corresponding one of the first light source and the second light source and the corresponding one of the light-emitting sections;
L1 is a width dimension of the lightguide; and
n is a refractive index of the lightguide.

11. The illumination unit as set forth in claim 1, wherein:
each of the first light source and the second light source is a group of point light sources in which group a plurality of point light sources of respective different types corresponding respectively to different emission colors are arranged along width of the corresponding one of the first lightguide section and the second lightguide section, where the width of each of the first lightguide section and the second lightguide section is a dimension perpendicular to a length thereof along a light traveling direction from the first light source or the second light source to the corresponding light-emitting section;
each of the first light source and the second light source is provided at a center of a length L1; and
each of the first lightguide section and the second lightguide section satisfies the following formula:
$$X \geq \frac{( L 1 + L 2 ) n \sqrt{\{ 1 - ( 1 / {n}^{2} ) \}}}{2} \qquad [ Formula 2 ]$$
where:
X is a distance, along the length of the corresponding one of the first lightguide section and the second lightguide section, between the corresponding one of the first light source and the second light source and the corresponding one of the light-emitting sections;
L2 is a distance between a rightmost one of the plurality of point light sources and a leftmost one of the plurality of point light sources;
L1 is a width dimension of the lightguide; and
n is a refractive index of the lightguide.

12. An illumination device comprising a plurality of illumination units each recited in claim 1, the plurality of illumination units being planarly disposed.

13. An illumination device comprising a plurality of illumination units each recited in claim 9, the plurality of illumination units being planarly disposed,
the plurality of illumination units being arrayed in such a manner that the illumination units are abutted with their adjacent illumination units at their portions at which the light-emitting surface and the opposite surface are closest, and spaces are formed below where the illumination units are abutted with their adjacent illumination units.

14. The illumination device as set forth in claim 13, wherein the plurality of illumination units are arrayed so that the spaces are connected with each other.

15. A liquid crystal display apparatus comprising, as a backlight, an illumination device recited in claim 12.
